(19) United States
(12) Patent Application Publication
(10) Pub. No.: US 2025/0206410 A1
(43) Pub. Date: Jun. 26, 2025

(54) SADDLE RIDING TYPE ELECTRIC VEHICLE

(71) Applicant: HONDA MOTOR CO., LTD., Tokyo (JP)

(72) Inventors: Kei Hasegawa, Tokyo (JP); Haruhiko Takasaki, Tokyo (JP); Atsuya Fujimoto, Tokyo (JP); Hiroaki Oda, Tokyo (JP); Naoki Matsuo, Tokyo (JP); Yuki Tashiro, Wako-shi (JP); Kyosuke Takekoshi, Tokyo (JP)

(21) Appl. No.: 18/953,138

(22) Filed: Nov. 20, 2024

(30) Foreign Application Priority Data
Dec. 20, 2023 (JP) 2023-215104

(51) Int. Cl. B62M 7/06; B62J 1/00; B62K 11/04; B62K 25/28; B62M 9/16

(52) U.S. Cl. CPC B62M 7/06; B62J 1/00; B62K 11/04; B62K 25/283; B62M 9/16

(57) ABSTRACT

A saddle riding type electric vehicle includes: a vehicle body frame having a head pipe, a main frame, a pair of right and left pivot frames, and upper and lower cross members that connect the right and left pivot frames to each other; a swing arm; and a power unit that is arranged at a further rearward side than the right and left pivot frames, wherein the power unit includes a unit case that accommodates the electric motor, the unit case includes a mount portion that is fastened by the upper and lower cross members in a vehicle forward-rearward direction between the right and left pivot frames, and a pivot shaft of the swing arm is supported by the right and left pivot frames and the mount portion.

### CROSS-REFERENCE TO RELATED APPLICATION

Priority is claimed on Japanese Patent Application No. 2023-215104, filed on Dec. 20, 2023, the contents of which are incorporated herein by reference.

### BACKGROUND

### Field of the Invention

The present invention relates to a saddle riding type electric vehicle.

### Background

In saddle riding type electric vehicles that travel using an output of an electric motor, there are a variety of arrangements of a battery used for vehicle travel, a control device, and an electric motor.

For example, in Japanese Unexamined Patent Application, First Publication No. 2020-97312, a plurality of batteries are arranged to be aligned in an upward-downward direction between right and left main frames, a control device is arranged between the battery and a pivot shaft, and an electric motor is arranged at a rearward side of the pivot shaft of a swing arm. A front portion of a motor case is fastened to a battery case and supports a front end portion of swing arm.

For example, in Japanese Unexamined Patent Application, First Publication No. 2012-91595, a battery is arranged between right and left main frames, a control device is arranged below the battery, and an electric motor is arranged at a forward side of a pivot frame. A motor case is fastened to the pivot frame.

### SUMMARY

In the configuration described above, when a configuration is employed in which the electric motor is arranged at the rearward side of the pivot shaft, and the motor case supports the swing arm, since the motor case receives a load relating to the output and the input of the electric motor and receives a load from the swing arm, an excessive stiffness is required. In this case, when the balance with a main frame at a vehicle body front part is also considered, adjustments of the strength and the stiffness of the motor case become complicated.

Specifically, in a saddle riding type electric vehicle which is a small vehicle, since an impact on a frame stiffness and a vehicle body design is large by a layout of a heavy drive component such as the battery, the control device, and the electric motor, there has been room for consideration.

An aspect of the present invention aims at providing a saddle riding type electric vehicle capable of reducing an impact on a vehicle body design by a layout of a drive component.

A saddle riding type electric vehicle according to a first aspect of the present invention includes: a vehicle body frame having a head portion that supports a steering wheel in a steerable manner, a main frame that extends rearward from the head portion, a pair of right and left pivot frames that extend downward from a rear end portion of the main frame, and a cross member that connects the right and left pivot frames to each other; a swing arm that supports a drive wheel; and a power unit that includes an electric motor for driving a vehicle and is arranged at a further rearward side than the pivot frame in a vehicle side view, wherein the power unit includes a unit case that accommodates the electric motor, the unit case includes a mount portion that is fastened by the cross member in a vehicle forward-rearward direction between the right and left pivot frames, and a pivot shaft of the swing arm is supported by the right and left pivot frames and the mount portion.

According to this configuration, the mount portion that is fastened to the vehicle body frame in the vehicle forward-rearward direction is provided on the unit case of the power unit that includes the electric motor for driving the vehicle, and thereby, the following advantages are achieved. That is, a structure is obtained in which a connection portion between the vehicle body frame and the power unit easily receives a load (load accompanied by acceleration and deceleration of the vehicle) due to the output and the input of the electric motor. Therefore, it is possible to reduce (disperse) the load on a fastening portion of the power unit and facilitate the adjustment of the strength and the stiffness of the unit case and the entire vehicle body. The pivot shaft of the swing arm is supported by the right and left pivot frames and the unit case, and thereby, it is possible to facilitate the adjustment of the strength and the stiffness of the unit case and optimize the case rigidity compared to the case where the pivot shaft is supported only by the unit case.

A second aspect of the present invention is the saddle riding type electric vehicle according to the first aspect described above, wherein the cross member may include an upper cross member that connects upper portions of the right and left pivot frames to each other and a lower cross member that connects lower portions of the right and left pivot frames to each other, an upper fastening portion that is fastened to the upper cross member may be provided on an upper portion of the mount portion, a lower fastening portion that is fastened to the lower cross member may be provided on a lower portion of the mount portion, and the lower fastening portion may be fastened to the lower cross member in a further inner range in a vehicle width direction than the upper fastening portion.

According to this configuration, the lower fastening portion of the unit case is fastened to the lower cross member in the further inner range in the vehicle width direction than the upper fastening portion, and thereby, it is possible to narrow the rightward-leftward width of a lower portion of the unit case as much as possible and easily ensure the bank angle of the vehicle body.

A third aspect of the present invention is the saddle riding type electric vehicle according to the first or second aspect described above, wherein each of the right and left pivot frames may include a pivot block as a separate body with respect to a main body side of the pivot frames, and each of right and left pivot blocks may support the pivot shaft of the swing arm and may be fastened in the vehicle forward-rearward direction with respect to the main body side of a right or left pivot frame on an identical side.

According to this configuration, by supporting the pivot shaft by the pivot block as the separate body with respect to a pivot frame main body and fastening the pivot block in the vehicle forward-rearward direction with respect to the pivot frame main body, the range of the fastening portion in the vehicle forward-rearward direction together with the fastening portion of the unit case is enlarged, and it is possible to enhance the joint stiffness to the main body side of the vehicle body frame of a unit case assembly body including the pivot block and the pivot shaft. The assembly body of the power unit, the pivot shaft, and the pivot block can be attached together to the main body side of the vehicle body frame by the fastening in a forward-rearward direction.

A fourth aspect of the present invention is the saddle riding type electric vehicle according to the third aspect described above, wherein a right or left step on an identical side may be attached to each of the right and left pivot blocks.

According to this configuration, by supporting the step by the right and left pivot blocks, it is possible to receive a step load by the pivot block having a high strength. Therefore, it is possible to facilitate the adjustment of the strength and the stiffness of the main body side of the vehicle body frame.

A fifth aspect of the present invention is the saddle riding type electric vehicle according to the third or fourth aspect described above, wherein a plurality of types of the right and left pivot blocks having a different axis center position of the pivot shaft may be set.

According to this configuration, by setting a plurality of types of the pivot blocks by differentiating the center position of the pivot shaft, it is possible to easily change a pivot position by replacing the pivot block, and it is possible to enhance the versatility of the vehicle component.

A sixth aspect of the present invention is the saddle riding type electric vehicle according to any one of the first to fifth aspects described above which may include: a rear cushion that is connected to the swing arm, wherein the rear cushion may be arranged above the power unit in an attitude in which a stroke direction is directed in the vehicle forward-rearward direction, may have a front end portion that is connected to the vehicle body frame or the power unit at a further forward side than a drive shaft of the electric motor, and may have a rear end portion that is connected to the swing arm at a further rearward side than the drive shaft of the electric motor.

According to this configuration, the rear cushion is arranged so as to extend in the vehicle forward-rearward direction across the drive shaft of the electric motor, the front end portion of the rear cushion is connected to the vehicle body frame or the power unit, and the rear end portion of the rear cushion is connected to the swing arm. By connecting the front end portion of the rear cushion to a section to which the vehicle body frame and the power unit are fastened to enhance the stiffness, it is possible to support the front end portion of the rear cushion with a high stiffness without additionally providing a reinforcement at the connection section of the front end portion of the rear cushion. Since the rear cushion extends in the vehicle forward-rearward direction across the drive shaft of the electric motor above the power unit, it is possible to efficiently ensure the stroke amount of the rear cushion while avoiding the power unit arranged at the rearward side of the pivot frame and prevent a retreat of the rear wheel and an increase in a wheelbase compared to the case where the rear cushion is arranged between the power unit and the rear wheel.

A seventh aspect of the present invention is the saddle riding type electric vehicle according to the sixth aspect described above, wherein the swing arm may include a pair of right and left arm main bodies and an arm connection portion that connects the right and left arm main bodies to each other, the right and left arm main bodies may be curved so as to be protrude upward in a vehicle side view, the arm connection portion may connect upper end portions of the right and left arm main bodies to each other, and a link mechanism that connects the rear end portion of the rear cushion to the swing arm may be arranged on an inside of the arm connection portion.

According to this configuration, the right and left arm main bodies of the swing arm have a bent shape that protrudes upward, and the upper end portions of the right and left arm main bodies are connected by the arm connection portion. Since the arm connection portion is arranged close to an upper portion of the swing arm, the right and left arm main bodies are efficiently connected to each other while avoiding the power unit at the rearward side of the pivot frame, and the rear end portions of the rear cushion arranged above the power unit are easily connected. Since the link mechanism that is connected to the rear end portion of the rear cushion is arranged at the inside of the arm connection portion, a setting flexibility of suspension characteristics is enhanced by the link mechanism, and it is possible to compactly constitute a link-type rear suspension.

An eighth aspect of the present invention is the saddle riding type electric vehicle according to any one of the first to seventh aspects described above, wherein the vehicle body frame may include: a box shape part which includes a pair of right and left side wall portions that extend below the right and left main frames, respectively, a bottom wall portion that connects lower ends of the right and left side wall portions to each other, and a front wall portion that connects front ends of the right and left side wall portions to each other.

According to this configuration, the box shape part including the right and left side wall portions, the bottom wall portion, and the front wall portion is provided below the right and left main frames of the vehicle body frame, and thereby, the box shape part can be utilized as a support structure of a battery mounted between the right and left main frames. Thereby, the number of components is reduced by eliminating or simplifying a structure for supporting the battery, and the stiffness of the vehicle body frame on which the battery which is a heavy object is mounted can be enhanced by the box shape part.

A ninth aspect of the present invention is the saddle riding type electric vehicle according to the eighth aspect described above which may include: a control device that controls driving of the electric motor, wherein the control device may be fastened to a lower surface of the bottom wall portion of the box shape part.

According to this configuration, by fastening the control device to the lower surface of the box shape part of the vehicle body frame, the number of components is reduced by eliminating or simplifying a structure for supporting the control device, the bottom wall portion of the box shape part is reinforced by the fastening of the control device, and it is possible to further enhance the stiffness of the vehicle body frame. A tenth aspect of the present invention is the saddle riding type electric vehicle according to any one of the first to ninth aspects described above, wherein the electric motor may be arranged at a height that overlaps the control device when seen from the vehicle forward-rearward direction.

According to this configuration, by arranging the control device and the electric motor at the height that overlaps each other, not only the control device and the battery mounted at the inside of the box shape part are close to each other, but also the control device and the electric motor are close to each other. Thereby, it is possible to shorten an electric power line among the battery, the control device, and the electric motor and concentrate the mass by a collected arrangement of heavy objects.

An eleventh aspect of the present invention is the saddle riding type electric vehicle according to any one of the first to tenth aspects described above, wherein the electric motor and the drive wheel may be connected via a transmission member having an endless form, and a tensioner that applies a tension to the transmission member may be supported by the unit case of the power unit.

According to this configuration, by supporting the tensioner for the transmission member by the unit case, it is possible to efficiently apply the tension to the transmission member in the vicinity of the power unit.

According to the aspect of the present invention, it is possible to provide a saddle riding type electric vehicle capable of reducing an impact on a vehicle body design by the layout of a drive component.

### BRIEF DESCRIPTION OF THE DRAWINGS

FIG. 1 is a left side view of an electric motorcycle of an embodiment.

FIG. 2 is a left side view of a main part of the electric motorcycle.

FIG. 3 is a perspective view of a rear wheel suspension system and a power unit of the electric motorcycle.

FIG. 4 is a perspective view further showing a vehicle body frame in FIG. 3.

FIG. 5 is a front view of a main part of FIG. 4 when seen from a forward direction.

FIG. 6 is a perspective view of a configuration of FIG. 2 when obliquely seen from an upper rear side.

FIG. 7 is a perspective view of the vehicle body frame when obliquely seen from an upper rear side.

FIG. 8 is a left side view showing a main part of the rear wheel suspension system.

FIG. 9 is a left side view including a partial cross section of the rear wheel suspension system.

FIG. 10 is a front view of a swing arm.

FIG. 11 is a rear view of the swing arm.

FIG. 12 is a top view of the swing arm.

FIG. 13 is a perspective view of a lower section of a mount portion.

FIG. 14 is a perspective view showing a modification example of a connection terminal portion and a recess portion.

FIG. 15 is a perspective view corresponding to FIG. 3 showing a first modification example of the embodiment.

FIG. 16 is a front view of a rear wheel suspension system of the first modification example.

FIG. 17 is a right side view of a main part of the first modification example.

FIG. 18 is a perspective view of a periphery of a pivot adjuster of the first modification example.

FIG. 19 is a perspective view showing a vehicle body frame of a second modification example of the embodiment.

FIG. 20 is a front view of the vehicle body frame of the second modification example.

### DESCRIPTION OF EMBODIMENTS

Hereinafter, an embodiment of the present invention will be described with reference to the drawings. Directions such as forward, rearward, rightward, and leftward directions in the following description are the same as directions in a vehicle described below unless otherwise stated. Further, in appropriate positions in the drawings used in the following description, an arrow FR that indicates a vehicle forward direction, an arrow LH that indicates a vehicle leftward direction, an arrow UP that indicates a vehicle upward direction, and a line CL that indicates a vehicle body rightward-leftward middle are shown.

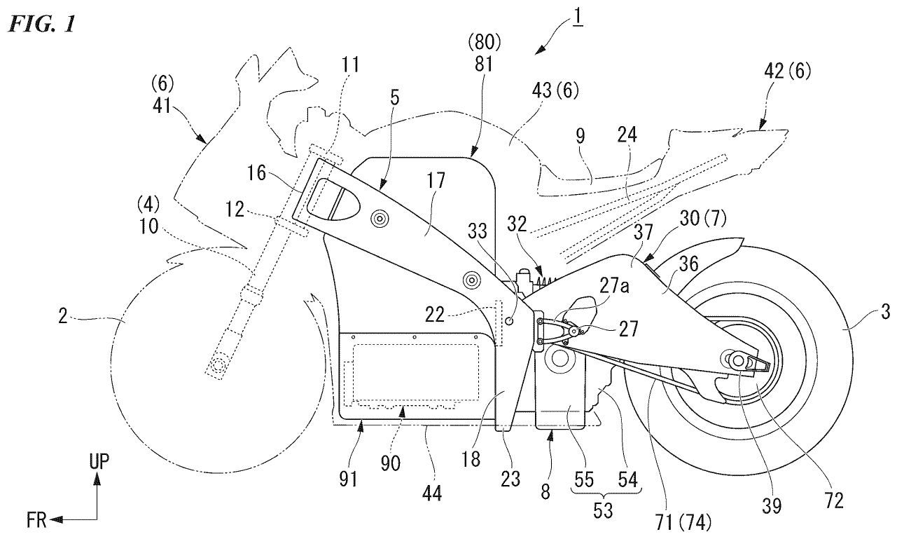

FIG. 1 is a left side view of an electric motorcycle (saddle riding type electric vehicle) 1 of an embodiment.

As shown in FIG. 1, the electric motorcycle 1 of the embodiment is an on-road type saddle riding type electric vehicle in which the size and the weight of a vehicle body is reduced, the mass is concentrated, and the center of gravity is lowered.

The electric motorcycle 1 includes a front wheel 2, a rear wheel 3, a front wheel suspension system 4, a vehicle body frame 5, a vehicle body cover 6, a rear wheel suspension system 7, a power unit 8, a battery unit 80, and a PCU (control device) 90.

The front wheel suspension system 4 includes a pair of right and left front forks 10 that pivotally support the front wheel 2 at a lower end portion, a top bridge 11 and a bottom bridge 12 that are provided between upper portions of the pair of front forks 10, and a stem pipe (not shown) that is provided between the top bridge 11 and the bottom bridge 12 and is inserted into a head pipe 16. The front wheel 2 is supported by the head pipe 16 of the vehicle body frame 5 via the front wheel suspension system 4 in a steerable manner. For example, a steering handle (not shown) is attached onto the top bridge 11. In the embodiment, a telescopic-type front fork 10 is shown as an example as a front suspension of the electric motorcycle 1; however, the embodiment is not limited to this configuration. For example, the front suspension may be of another type such as a link type using a swing arm.

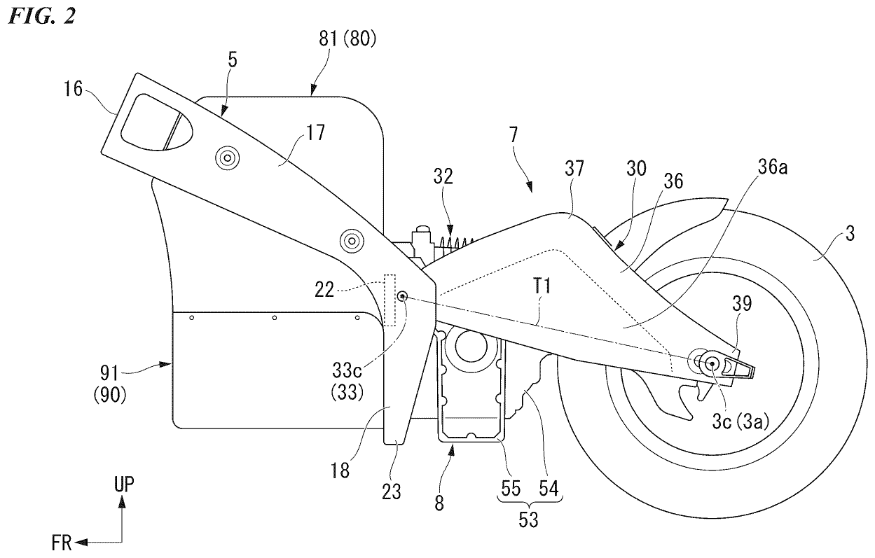

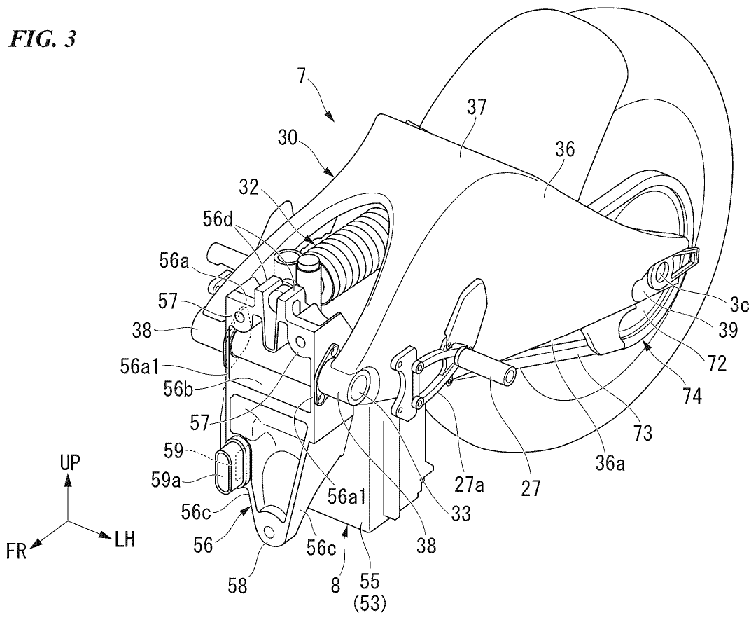

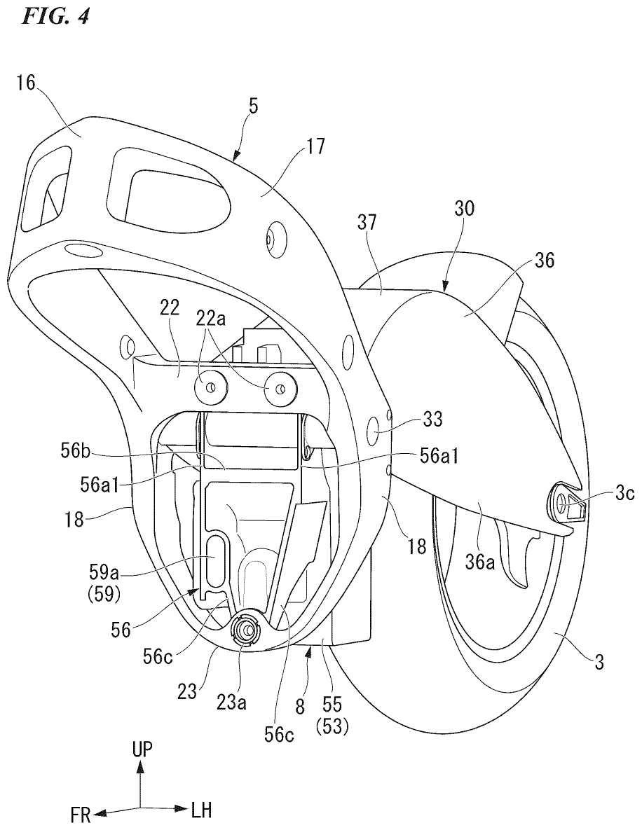

FIG. 2 is a left side view of a main part of the electric motorcycle 1, FIG. 3 is a perspective view of the power unit and the rear wheel suspension system 7 of the electric motorcycle 1, and FIG. 4 is a perspective view further showing the vehicle body frame 5 in FIG. 3.

With reference to FIG. 1, FIG. 2, and FIG. 4, the vehicle body frame 5 includes the head pipe 16, a pair of right and left main frames 17, a pair of right and left pivot frames 18, an upper cross member 22 that connects upper portions of the right and left pivot frames 18 to each other, and a lower cross member 23 that connects lower portions of the right and left pivot frames 18 to each other.

A single head pipe 16 is located at a vehicle body rightward-leftward middle CL and is provided on a front end of the vehicle body frame 5. The head pipe 16 is inserted through the stem pipe and is rotatably supported. The shape of the head pipe 16 is not limited to a cylindrical shape, and an irregularity, an opening, or the like may be appropriately formed on the head pipe 16.

The pair of main frames 17 branch to a right and a left from an upper portion of the head pipe 16 and extend rearward and downward. In a plan view seen from above, front portions of the pair of main frames 17 obliquely extend to a rearward side of the head pipe 16 and outward in a vehicle width direction and are then curved to extend rearward. In the plan view seen from above, rear portions of the pair of main frames 17 extend straight along a forward-rearward direction. The front portions of the pair of main frames 17 have an upward-downward width similar an axis direction length of the head pipe 16 in a side view. The rear portions of the pair of main frames 17 are formed so as to narrow an upward-downward width toward a rear lower side in the side view. Each of the pair of pivot frames 18 extends downward from a rear end portion of the right or left main frame 17 on the same side. A pivot shaft 33 that extends in the vehicle width direction is provided between middle portions of the pair of pivot frames 18 close to an upper portion in an upward-downward direction. The term “middle” used in the embodiment includes not only a middle between both ends of a target but also an inner range between both ends of the target.

The upper cross member 22 extends in the vehicle width direction above the pivot shaft 33 and connects upper portions of the pair of pivot frames 18 to each other. A pair of right and left upper fastening portions 22a that fasten an upper portion of a mount portion 56 of a unit case 53 of the power unit 8 is provided on an outer side in the vehicle width direction of the upper cross member 22.

The lower cross member 23 extends in the vehicle width direction below the pivot shaft 33 and connects lower portions of the pair of pivot frames 18 to each other. A single lower fastening portion 23a that fastens a lower portion of the mount portion 56 of the unit case 53 of the power unit 8 is provided on a middle portion in the vehicle width direction of the lower cross member 23.

With reference to FIG. 1, the vehicle body frame 5 further includes a rear frame 24 that supports a seat 9 for occupant seating. For example, a front end portion of the rear frame 24 is fixed by bolting or the like in an attachable and detachable manner to a rear upper side of the right and left main frames 17. A step bracket 27a that supports right and left steps 27 is fixed by bolting in an attachable and detachable manner to a rear portion of the right and left pivot frames 18.

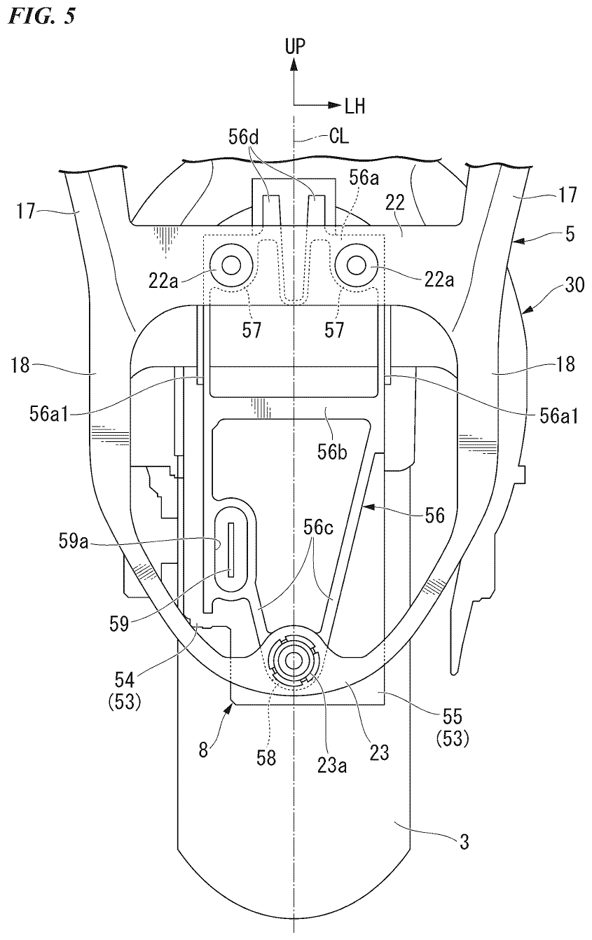

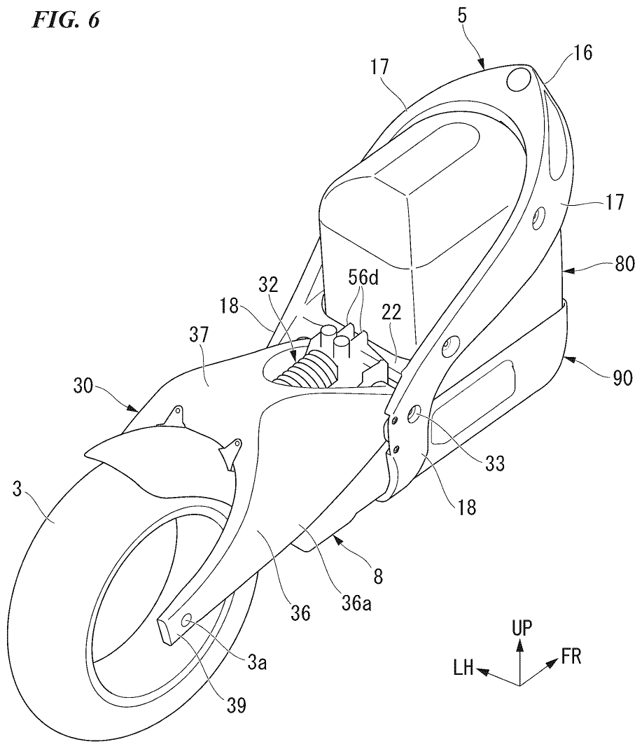

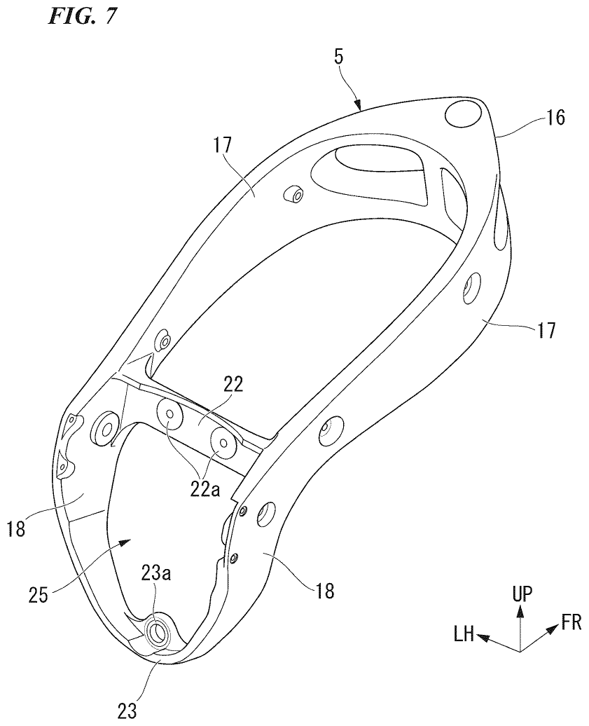

FIG. 5 shows a front view of a main part of FIG. 4 when seen from a forward direction, FIG. 6 shows a perspective view of a configuration of FIG. 2 when obliquely seen from an upper rear side, and FIG. 7 shows a perspective view of the vehicle body frame 5 when obliquely seen from an upper rear side.

With reference to FIG. 1, FIG. 2, and FIG. 6, a battery unit 80 for traveling is mounted on the vehicle body frame 5 between the right and left main frames 17 at a rearward side of the head pipe 16 and a forward side of the right and left pivot frames 18.

The battery unit 80 is capable of being inserted into and detached from in a space formed between the right and left main frames 17 in a plan view from above. The battery unit 80 is sandwiched by the right and left main frames 17 from the outer side in the vehicle width direction and is thereby protected from an external disturbance from the outer side in the vehicle width direction.

The vehicle body frame 5 supports the power unit 8 for traveling of the vehicle at a rearward side of the right and left pivot frames 18.

The power unit 8 includes an electric motor 50 and a speed reducer 51, and the electric motor 50 and the speed reducer 51 are accommodated in an integrated unit case 53. The power unit 8 is fastened and fixed to a bulkhead portion 25 formed of the upper and lower cross members 22, 23 and the right and left pivot frames 18 in the vehicle body frame 5 from a vehicle rearward side. Even in a configuration in which the power unit 8 is supported at the rearward side of the right and left pivot frames 18, by arranging the battery unit 80 closer to the head pipe 16, forward-rearward weight distribution can be made appropriate.

With reference to FIG. 1, the vehicle body cover 6 covers the vehicle body frame 5 and the like. The vehicle body cover 6 includes a front cowl 41, a rear cowl 42, a seat front cover 43, and a under cowl 44.

The front cowl 41 covers a range extending from a forward side of the head pipe 16 to right and left sides, and right and left side portions of the front cowl 41 extend further rearward and cover a vehicle body side part from the outer side in the vehicle width direction.

The rear cowl 42 covers a range extending from right and left side portions of the rear frame 24 to a rearward side. The seat 9 is arranged on the rear cowl 42. The seat front cover 43 is formed such that a space between the right and left main frames 17 projects upward at the forward side of the seat 9. The seat front cover 43 is a tank cover having an outer shape that simulates a fuel tank. The seat front cover 43 forms a knee grip portion that is sandwiched between both knees of an occupant seated on the seat 9. An upper portion of the battery unit 80 is accommodated inside the seat front cover 43. The seat front cover 43 covers the upper portion of the battery unit 80 from above.

The under cowl 44 continues to a lower side of the front cowl 41 and covers a vehicle body lower part from below.

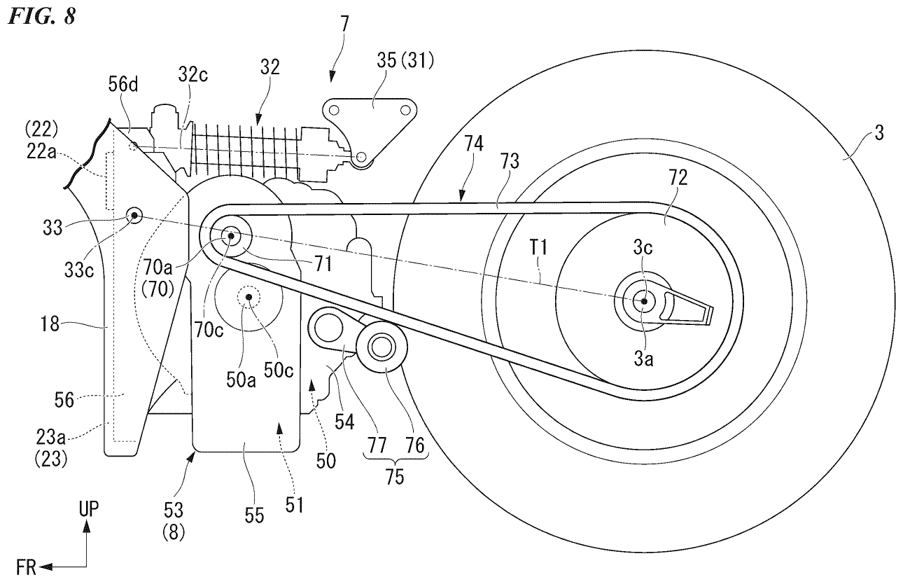

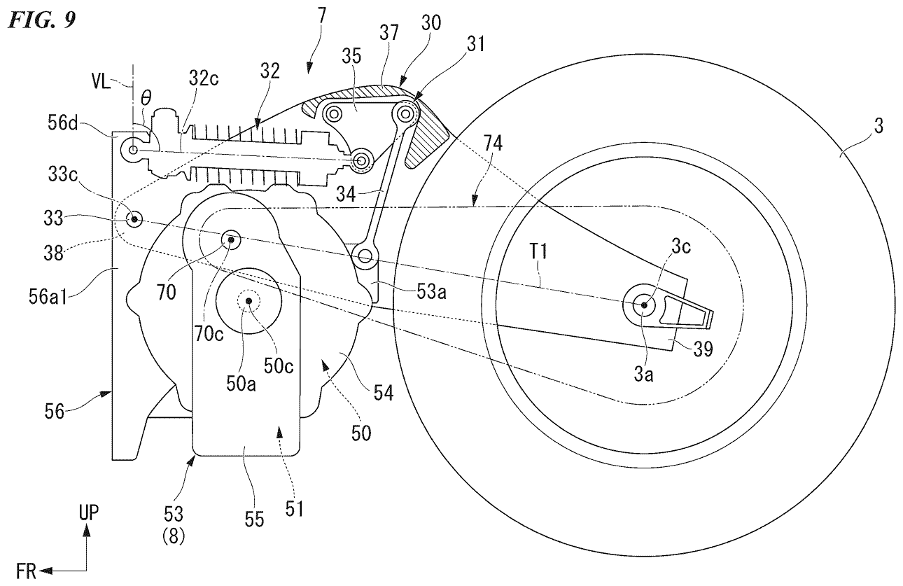

FIG. 8 is a left side view showing a main part of the rear wheel suspension system 7, and FIG. 9 is a left side view including a partial cross section of the rear wheel suspension system 7.

With reference to FIG. 8 and FIG. 9, the rear wheel suspension system 7 includes a swing arm 30 that pivotally supports the rear wheel 3 at a rear end portion, a link mechanism 31 that is connected to a front upper portion of the swing arm 30, and a rear cushion 32 that extends between the link mechanism 31 and the upper cross member 22.

The swing arm 30 is arranged below a vehicle body rear part and extends in the forward-rearward direction. A front end portion of the swing arm 30 is supported so as to be swingable upward and downward via the pivot shaft 33 by the pair of pivot frames 18 and the mount portion 56 of the unit case 53. The mount portion 56 is a fastening portion among the vehicle body frame 5, the power unit 8, the swing arm 30, the rear cushion 32, and the like and easily obtains a support stiffness of the pivot shaft 33.

The link mechanism 31 includes a link arm 34 that extends in an upward-downward direction and a link member 35 having an inverted triangular shape in a side view. The link arm 34 is arranged at the inside of an upper protrusion portion (an arm connection portion 37) formed on a front upper portion of the swing arm 30 in the side view. The link arm 34 extends downward from the inside of the upper protrusion portion and has a lower end portion that is rotatably connected to a link connection portion 53a at a rear end portion of the unit case 53. An upper end portion of the link arm 34 is rotatably connected to a rear end apex portion of the link member 35. A front end apex portion of the link member 35 is rotatably connected to the upper protrusion portion of the swing arm 30. A rear end portion of the rear cushion 32 is rotatably connected to a lower end apex portion of the link member 35. A front end portion of the rear cushion 32 is rotatably connected to a cushion front connection section 56d of the mount portion 56. By the action of the link mechanism 31, it is possible to obtain a progressive effect in which a cushion stroke is decreased when a rear load is small and the swing of the swing arm 30 is small, and the cushion stroke is increased when the rear load is large and the swing of the swing arm 30 is large.

The rear cushion 32 is provided at the inside (for example, on the vehicle body rightward-leftward middle CL) in the vehicle width direction of the vehicle body rear part. The rear cushion 32 is formed in a cylindrical shape in which a compression coil spring is arranged on an outer circumference of a damper cylinder and is arranged in a horizontal attitude in which an axis direction is generally along a vehicle forward-rearward direction. The rear cushion 32 is arranged above the power unit 8 and extends in the forward-rearward direction.

The cushion front connection section 56d that is connected to a front end portion of the rear cushion 32 is located in the vicinity of an upper fastening portion 57 (a fastening section with the vehicle body frame 5) of the mount portion 56 and shares the strength and the stiffness in the vicinity of the upper fastening portion 57.

In the rear cushion 32, for example, an angle (angle of a center axial line) θ with respect to a vertical line VL in the side view is set in a range from 45 degrees to 120 degrees. The rear cushion 32 is arranged so as to fit within an upward-downward width of the swing arm 30. The rear cushion 32 is arranged substantially horizontally while avoiding the electric motor 50 that has a large diameter and is arranged at a rearward side of the pivot frame 18. Thereby, the arrangement of the rear cushion 32 does not affect a wheelbase, and a stroke amount of the rear cushion 32 and a damper capacity are ensured. By reducing an upward-downward direction height of an arrangement portion of the rear cushion 32, a space below the seat is opened, and the present embodiment becomes applicable also to a vehicle in which a seat height is low.

The power unit 8 includes the electric motor 50 for driving the vehicle, the speed reducer 51 that decelerates an output of the electric motor 50, an output shaft 70 that outputs the power of the electric motor 50 decelerated in the speed reducer 51, and the unit case 53 that accommodates a drive portion such as the electric motor 50 and the speed reducer 51. The power unit 8 is constituted as an integral unit that includes the electric motor 50, the speed reducer 51, the output shaft 70, and the unit case 53.

The electric motor 50 includes a drive shaft (motor drive shaft) 50a and is arranged such that an axis direction of the drive shaft 50a is along the vehicle width direction. A gear-type speed reducer 51 is arranged on one side (left side) in a rightward-leftward direction of the electric motor 50.

The output shaft 70 extends in the vehicle width direction and has a left end portion 70a that protrudes to the outside of the unit case 53. The output shaft 70 is located at an upper front side of the motor drive shaft 50a in the side view. In the power unit 8, the output shaft 70 and the motor drive shaft 50a are provided as a separate shaft from each other. The output shaft 70 and the motor drive shaft 50a may be provided coaxially with each other in accordance with the configuration of the speed reducer 51 or the like.

The unit case 53 forms an outer shape of the power unit 8. The unit case 53 is integrally includes: a motor case 54 that has a drum shape and accommodates the electric motor 50; a gear case 55 that has a box shape, is arranged on a left side portion of the motor case 54, and accommodates the speed reducer 51; and the mount portion 56 that is provided on a front portion of the unit case 53.

With reference to FIG. 8, the left end portion 70a of the output shaft 70 protrudes to the outside of the unit case 53, and the left end portion 70a is connected to the rear wheel 3 via a chain-type transmission mechanism 74. Reference numeral 71 in the drawing represents a drive sprocket that is attached to the left end portion 70a of the output shaft 70, reference numeral 72 represents a driven sprocket that is attached to the left side of the rear wheel 3, and reference numeral 73 represents a drive chain that has an endless form and is hung on both sprockets 71, 72.

A tensioner 75 that applies a tension to the drive chain 73 is supported by a lower portion of the unit case 53 of the power unit 8.

The tensioner 75 causes a tensioner pulley 76 to be in contact with the drive chain 73 from an outer circumferential side of a winding region of the drive chain 73 in the side view. The tensioner pulley 76 is supported by a rear left side of the unit case 53 via a tensioner arm 77.

The tensioner arm 77 extends rearward along a lower side (a slack side) of the drive chain 73 in the side view and supports the tensioner pulley 76 at a rear end portion. In the tensioner arm 77, a front end portion is rotatably supported by the unit case 53, and a rear end portion is biased upward (to the drive chain 73 side). The tensioner 75 causes the tensioner pulley 76 to be in contact with the drive chain 73 with a biasing force and applies an appropriate tension to the drive chain 73. The tensioner 75 is provided in a space having a crescent shape at the rearward side of the gear case 55 in a left side portion of the motor case 54. The tensioner 75 applies the tension to the drive chain 73 in the vicinity of a middle between the output shaft 70 and a rear wheel axle 3a. Thereby, the tension can be efficiently applied to the drive chain 73 with a low force.

Although the embodiment is described using the chain-type transmission mechanism 74 as an example, a belt-type transmission mechanism may be employed. The tensioner 75 can have a configuration corresponding to a transmission component such as a drive belt or the drive chain 73.

With reference to FIG. 1, the PCU (Power Control Unit) 90 that controls the electric motor 50 is arranged below the power unit 8. The PCU 90 is a control device that includes a PDU (Power Drive Unit) which is a motor driver, an ECU (Electric Control Unit) that controls the PDU, and the like. The PDU includes an inverter. The PDU converts a current supplied from the battery unit 80 from a direct current to an alternate current and then supplies electric power to the electric motor 50.

The PCU 90 is accommodated in a PCU cover 91 that is formed in a cuboid shape so as to continue to a lower side of the battery case 81. By including the PCU cover 91, an external disturbance is prevented from reaching the PCU 90, and an operation sound generated by the PCU 90 is less likely to diffuse to the vicinity. A sound absorption material may be mounted on the PCU cover 91, or the cover itself may be formed of a material that absorbs sound.

A lower end portion of the PCU 90 is at a height similar to that of a lower end portion (a lower end portion of the lower cross member 23 in the embodiment) of the vehicle body frame 5. The circumference of the PCU 90 is covered from below by the under cowl 44 that continues to the lower side of the front cowl 41.

The mount portion 56 formed on a front portion of the unit case 53 is fastened to the bulk head portion 25 of the vehicle body frame 5, and thereby, the power unit 8 is connected to (supported by) the vehicle body frame 5. The bulk head portion 25 is formed of the right and left pivot frames 18 and the upper and lower cross members 22, 23 in a frame shape that opens in the forward-rearward direction. The bulk head portion 25 may have, for example, a wall that closes the opening portion. In this case, it is possible to make it difficult for the operation sound of the power unit 8 to reach the forward side (occupant side).

Most part of the power unit 8 except for the mount portion 56 is arranged at a further rearward side than the right and left pivot frames 18 in a side view. An upper portion of the power unit 8 is arranged so as to enter the inside (between front portions of right and left arm main bodies 36) of a front portion of the swing arm 30 in the side view. The rear wheel suspension system 7 in FIG. 8 and FIG. 9 shows an attitude when the vehicle is in an empty vehicle 1G state (stationary state in which a vehicle weight is added). A lower end portion of the power unit 8 is at a height similar to that of a lower end portion (lower cross member 23) of the vehicle body frame 5. The lower end portion of the power unit 8 is covered from below by a rearward extension portion of the under cowl 44.

A first pivot shaft support portion through which the pivot shaft 33 penetrates and which supports the pivot shaft 33 is provided on the mount portion 56. Since the pivot shaft 33 penetrates through the first pivot shaft support portion, the first pivot shaft support portion is arranged at a position that avoids the electric motor 50 in the side view. Therefore, the first pivot shaft support portion is located at the outside of the unit case 53 in the side view. From the viewpoint of avoiding an increase in the size of the unit case 53, it is difficult for the first pivot shaft support portion to be a large structure that can ensure the strength and the stiffness by itself. In the embodiment, the mount portion 56 is fastened to the bulk head portion 25, and thereby, the strength and the stiffness of the first pivot shaft support portion is ensured. Further, in addition to the pivot shaft 33 being supported by the mount portion 56, right and left side portions of the pivot shaft 33 are supported by the right and left pivot frames 18, respectively. Thereby, it possible to prevent the increase in the size of the unit case 53 while enhancing a pivot stiffness of the swing arm 30. A pivot shaft support portion in the right and left pivot frames 18 is referred to as a second pivot shaft support portion.

With reference to FIG. 1, FIG. 2, and FIG. 6, the battery unit 80 defines a cuboid shape that is elongated in the upward-downward direction and is accommodated in the battery case 81 having a similar shape. The battery unit 80 obtains a predetermined high voltage, for example, by connecting a plurality of unit batteries in series. The battery unit 80 is formed so as to fit between inner surfaces in the vehicle width direction of the right and left main frames 17 in a plan view.

The battery unit 80 is arranged such that an upper portion protrudes above the main frame 17, and a lower portion protrudes below the main frame 17 in a side view. A portion of the battery unit 80 that protrudes above the main frame 17 is covered by the seat front cover 43 from above. The main frame 17 is arranged so as to diagonally cross on the outer side in the vehicle width direction of the battery unit 80. A portion of the battery unit 80 that protrudes below the main frame 17 is covered by both side sections (side cowls) of a rear portion of the front cowl 41 from right and left outer sides.

The PCU 90 is arranged below the battery unit 80 so as to continue to the battery unit 80. Thereby, the length of a high-voltage cable (a positive cable and a negative cable) that extends from the battery unit 80 is reduced. The power unit 8 is arranged at a rearward side of the PCU 90 so as to be adjacent to the PCU 90 in the forward-rearward direction. The PCU 90 and the power unit 8 are arranged so as to overlap each other in the upward-downward direction and the rightward-leftward direction when seen from the forward-rearward direction. Thereby, the length of an electric power line (three-phase cable) between the PCU 90 and the power unit 8 is reduced.

The PCU 90 is arranged at a further forward side than the bulk head portion 25 and is provided below the battery unit 80. Thereby, even if the size of the PCU 90 is increased when the output of the electric motor 50 is increased, an impact of the PCU 90 on a fastening portion between the power unit 8 and the vehicle body frame 5 is avoided. Thereby, it is possible to reduce the impact on the stiffness of the vehicle body frame 5 or the like and improve the degree of freedom of a vehicle body design. Compared to the case where the PCU 90 is arranged at a further rearward side than the bulk head portion 25, a retreat of the rear wheel 3 and an increase in the wheelbase are prevented.

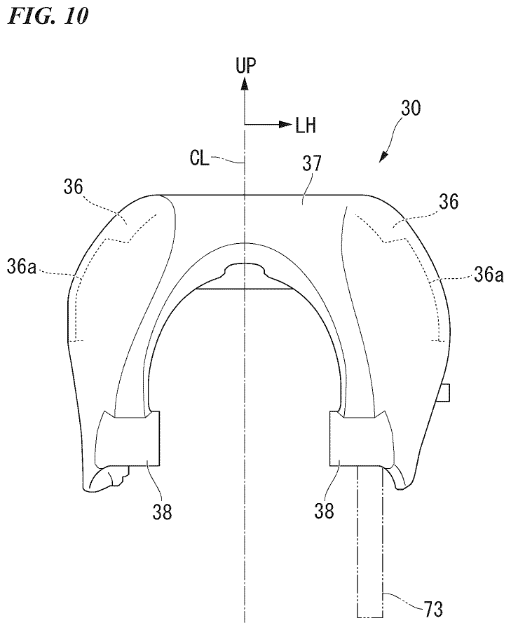

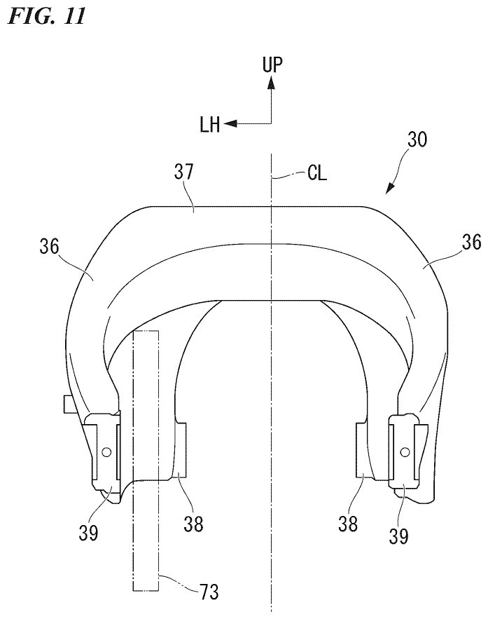

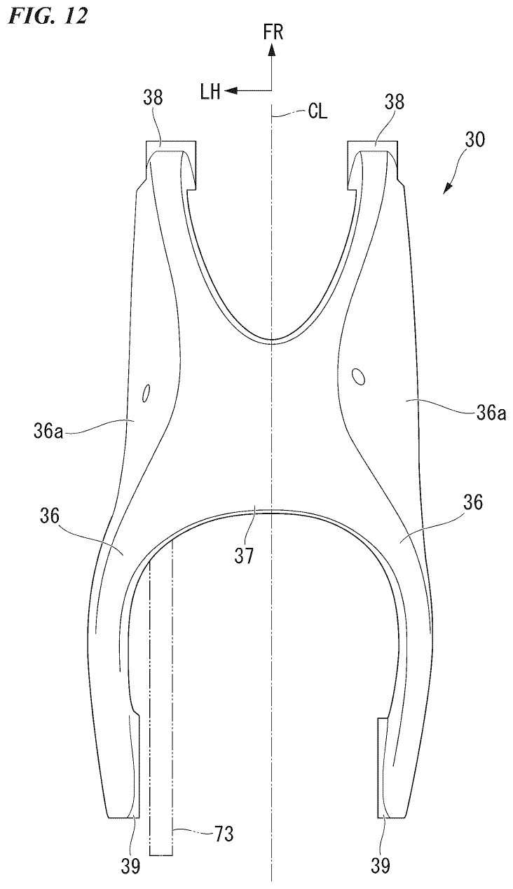

FIG. 10 is a front view of the swing arm, FIG. 11 is a rear view of the swing arm, and FIG. 12 is a top view of the swing arm.

With reference to FIG. 10 to FIG. 12, the swing arm 30 includes a pair of right and left arm main bodies 36 and the arm connection portion 37 that connects front portions of the right and left arm main bodies 36 to each other.

The right and left arm main bodies 36 define a bent shape that protrudes upward in the side view. The right and left arm main bodies 36 extend along the bent shape in the side view, for example, while having a rectangular hollow cross-sectional shape. A pivot support portion 38 which has a cylindrical shape and through which the pivot shaft 33 is inserted is provided on a front end portion of the right and left arm main bodies 36. An axle support portion 39 which has a plate shape and through which the rear wheel axle 3a is inserted is provided on a rear end portion of the right and left arm main bodies 36.

An upper end portion (apex portion) in a side view of the right and left arm main bodies 36 is located at a further forward position than a middle in the forward-rearward direction of the right and left arm main bodies 36. The arm connection portion 37 is provided so as to extend between upper end portions in the side view of the right and left arm main bodies 36. The inside of the arm connection portion 37 is appropriately thinned, and a rear portion of the rear cushion 32 and the link mechanism 31 are accommodated in the inside of the arm connection portion 37.

An upper portion of the power unit 8 is arranged between front portions of the right and left arm main bodies 36. Since the rear wheel 3 is arranged at the rearward side of the power unit 8 close to the power unit 8, the arm connection portion 37 between the right and left arm main bodies 36 is provided so as to bypass a proximity portion between the power unit 8 and the rear wheel 3 and pass above the proximity portion. A rear end portion of the rear cushion 32 is connected to the link mechanism 31 at the inside of the arm connection portion 37. A front end portion of the rear cushion 32 is connected to the cushion front connection section 56d on the mount portion 56 of the power unit 8.

In a side view, a straight line that connects a center 33c of the pivot shaft 33 to a center 3c of the rear wheel axle 3a is represented by reference numeral T1. The arm connection portion 37 is located at a higher position than the straight line T1 in the side view.

A center 50c of the motor drive shaft 50a of the power unit 8 is located at a lower position than the straight line T1. A center 70c of the output shaft 70 is located at a lower position than the straight line T1 but is arranged closer to the straight line T1 than the center 50c of the drive shaft 50a. The motor drive shaft 50a and the output shaft 70 are located at a further rearward position than the pivot shaft 33. A lower edge in a side view of the swing arm 30 is formed below the straight line T1 and substantially in parallel with the straight line T1.

The swing arm 30 includes an arm plate portion 36a that closes a range having a triangular shape in the side view below each of the right and left arm main bodies 36. In the swing arm 30, the right and left arm main bodies 36 have a hollow cross-sectional shape, and the right and left arm plate portions 36a have a plate shape in the cross section. The right and left arm plate portions 36a is formed in a plate shape having a thickness similar to that of a wall portion on the outside in the vehicle width direction of the right and left arm main bodies 36 on the same side. Outer side surfaces of the right and left arm plate portions 36a are formed to be flush with outer side surfaces of wall portions on the outer side in the vehicle width direction of the right and left arm main bodies 36 on the same side. The swing arm 30 has a shape like an arm shape in which an upward-downward height is increased in the side view, but a skeleton part is the right and left arm main bodies 36 having a bent shape.

Since lower sides of the right and left arm main bodies 36 are the right and left arm plate portions 36a having a plate shape, the stiffness of the swing arm 30 is not excessively increased. Specifically, since the right and left arm plate portions 36a is less likely to be bent in a so-called in-plane direction, the longitudinal stiffness (a bending stiffness in the forward-rearward direction and the upward-downward direction) of the right and left arm main bodies 36 is effectively reinforced by the right and left arm plate portions 36a. Since the right and left arm plate portions 36a is easily bent in a so-called out-of-plane direction, excessive reinforcement of the lateral stiffness (a bending stiffness in the rightward-leftward direction) of the right and left arm main bodies 36 is prevented.

In a front portion of the swing arm 30, a higher section than the straight line T1 in the side view is formed such that the rightward-leftward width is narrower toward an upper position (arm connection portion 37 side). Thereby, the rightward-leftward width in the vicinity (near the arm connection portion 37) of an upper end portion of the swing arm 30 is narrowed and becomes compact, and an impact on the arrangement of a peripheral component is reduced. Since a protrusion shape is not provided on a lower side than a portion along the straight line T1, an impact on a bank angle of the vehicle body due to the increase of the rightward-leftward width of the portion is reduced.

In a rear portion of the swing arm 30, the right and left arm main bodies 36 between the arm connection portion 37 and a rear end portion (axle support portion 39) in the forward-rearward direction is formed in a curved shape that protrudes outward in the vehicle width direction in a plan view. Thereby, the rightward-leftward width between the right and left arm main bodies 36 is widened at a further forward side than the vicinity of the rear wheel axle 3a, and a clearance with a transmission component such as the drive chain 73 or the belt is easily ensured. Since the rightward-leftward width in the vicinity (near a lower end portion of the swing arm 30) of the rear wheel axle 3a is reduced, the impact on the bank angle of the vehicle body is reduced.

The right and left arm main bodies 36 and the arm plate portion 36a are smoothly curved so as to be continuous in an S shape in a plan view and have a shape in which stress concentration is less likely to occur.

The arm plate portion 36a of the left arm main body 36 may be provided to be extended in a side view so as to cover the entire chain-type transmission mechanism 74 from the outside in the vehicle width direction. In this case, the arm plate portion 36a can function like a chain cover, prevent an external article or the like from coming into contact with the drive chain 73, and prevent a chain noise from diffusing.

As shown in FIG. 3 to FIG. 5, the mount portion 56 that is fastened and fixed to the bulk head portion 25 of the vehicle body frame 5 is provided on a front end portion of the unit case 53 of the power unit 8.

The mount portion 56 is formed such that a rightward-leftward width is narrowed toward a lower side with respect to the gear case 55 and the motor case 54 having a rectangular shape in a forward-rearward direction view.

The mount portion 56 includes an upper wall section 56a, right and left side wall sections 56a1, a middle step wall portion 56b that is spaced apart to a lower side of the upper wall section 56a, and right and left inclination walls 56c that extend to a lower side of the right and left side wall sections 56a1. The mount portion 56 is formed in a hollow shape as a whole. The cushion front connection section 56d that is connected to a front end portion of the rear cushion 32 is provided to protrude at an upper position of the upper wall section 56a.

A connection terminal portion 59 for connecting a three-phase cable that extends from the PCU 90 is provided on another side (right side in the embodiment) of right and left sides of the right and left inclination walls 56c. The connection terminal portion 59 is arranged in a recess portion 59a formed so as to cut out the right inclination wall 56c of the mount portion 56 (at the inside of the mount portion 56).

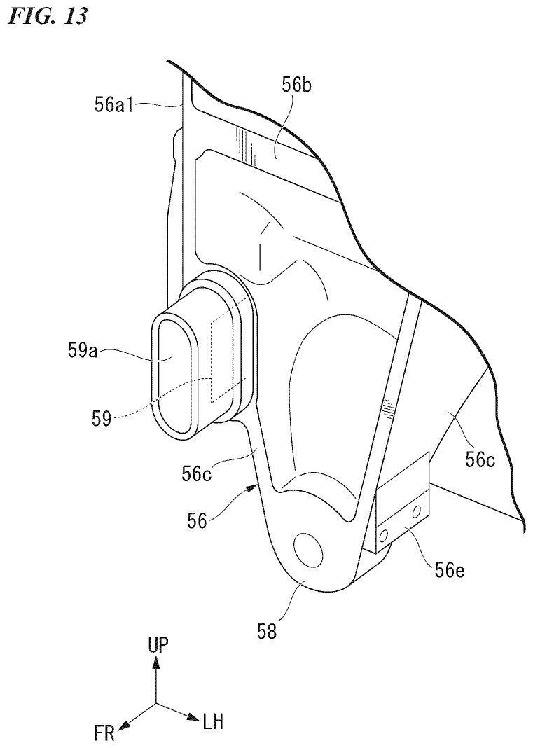

FIG. 13 is a perspective view of a lower section of the mount portion 56.

With reference to FIG. 13, a stand fixation portion 56e for fastening and fixing a stand bracket (not shown) that supports a side stand (not shown) may be provided on one side (left side in the embodiment) of right and left sides of the right and left inclination walls 56c. The stand fixation portion 56e is located in the vicinity of a lower fastening portion 58 (a fastening portion with the vehicle body frame 5) of the mount portion 56 and shares the strength and the stiffness in the vicinity of the lower fastening portion 58.

Thereby, the degree of freedom of the design of the strength and the stiffness of the lower portion of the vehicle body frame 5 is improved compared to the case where the stand fixation portion 56e is provided on the vehicle body frame 5.

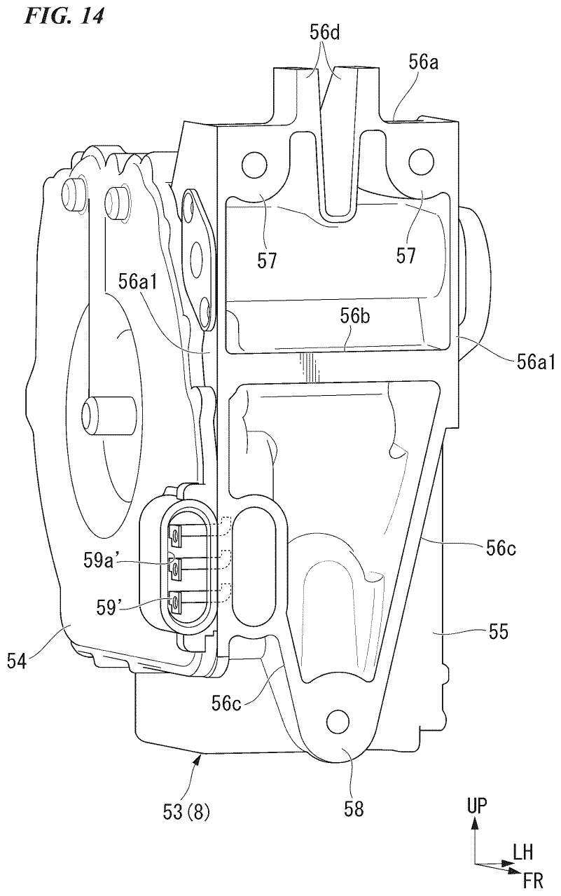

FIG. 14 is a perspective view showing a modification example of the connection terminal portion 59 and the recess portion 59a.

As in a connection terminal portion 59′ and a recess portion 59a′ shown in FIG. 14, the connection terminal portion 59′ and the recess portion 59a′ may be provided on an outer side (for example, a right cover of the motor case 54) of the mount portion 56. This is because the position of the connection terminal portion 59 or a bearing changes to the outer side in the axis direction when the thickness in the axis direction of a stator of the electric motor 50 is increased. By collecting such change points to right and left outer covers of the motor case 54, the repertoire of the power unit 8 can be easily increased, and it is possible to reduce costs.

With reference to FIG. 3 to FIG. 5, a pair of right and left upper fastening portions 57 that are fastened to the upper cross member 22 are provided on right and left corners on both sides of an upper section of the mount portion 56. A single lower fastening portion 58 that is fastened to the lower cross member 23 is provided on a lower end section of the mount portion 56. Each fastening portion 57, 58 butts a fastening section of the bulk head portion 25 from a rearward direction and is fastened by a bolt along the forward-rearward direction. Thereby, the power unit 8 that includes the electric motor 50 and the speed reducer 51, the pivot shaft 33 of the swing arm 30, and a front end portion of the rear cushion 32 can be collectively attached to the bulk head portion 25.

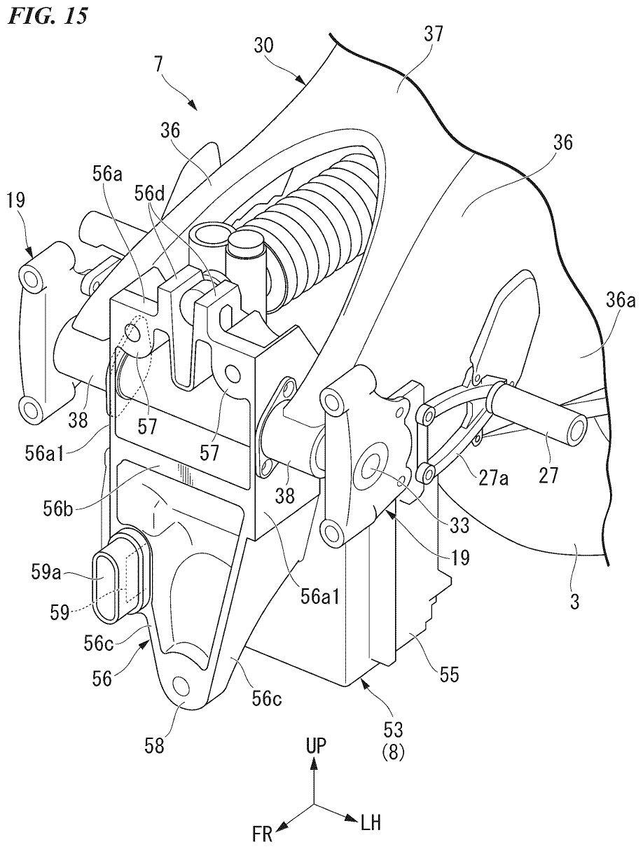

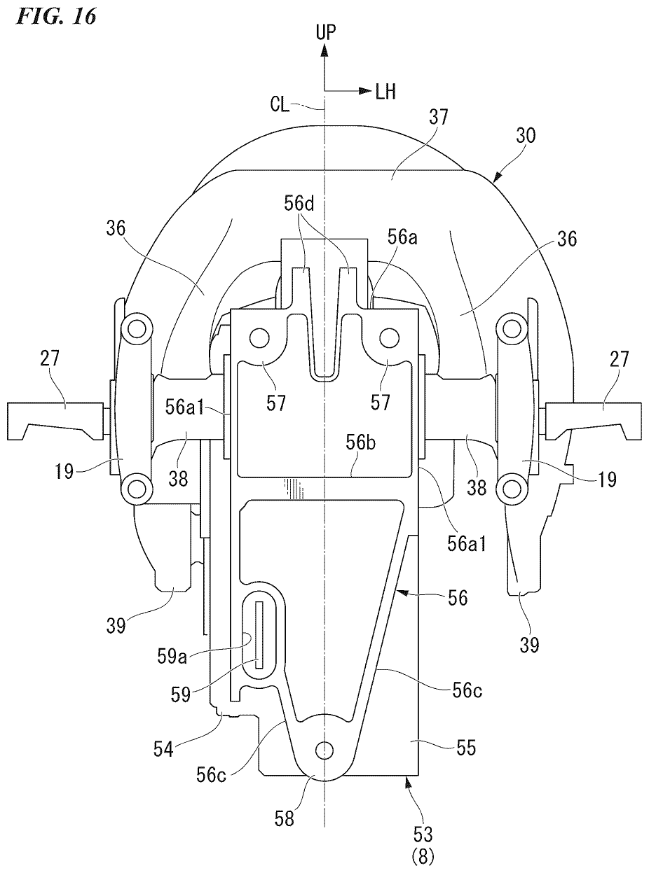

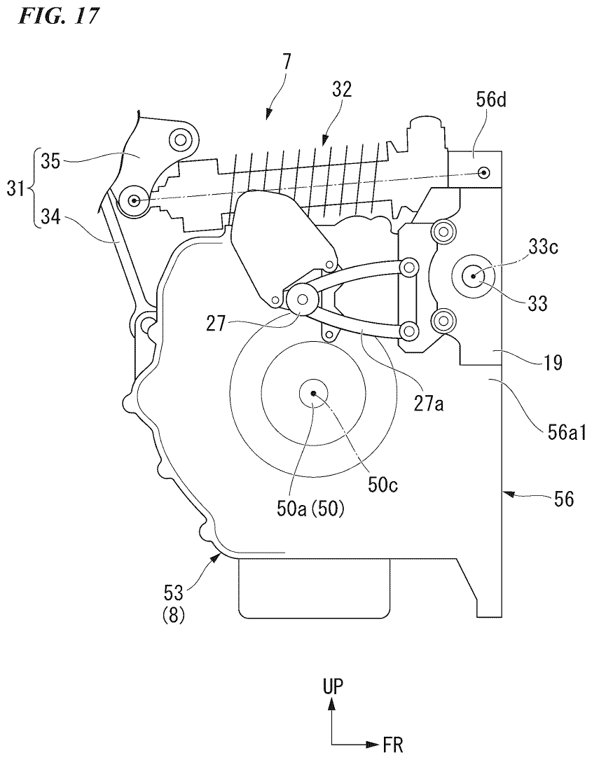

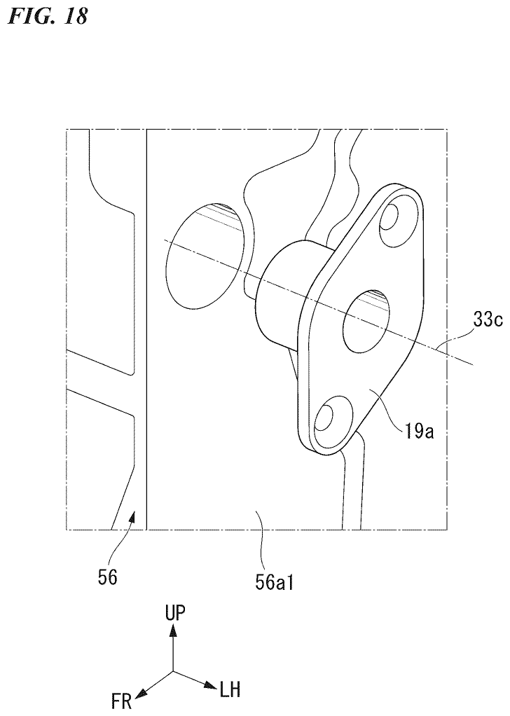

FIG. 15 is a perspective view corresponding to a main part of FIG. 3 showing a first modification example of the embodiment, FIG. 16 is a front view of the rear wheel suspension system 7 of the first modification example, FIG. 17 is a right side view of a main part of the first modification example, and FIG. 18 is a perspective view of a periphery of a pivot adjuster 19a of the first modification example.

As shown in FIG. 15 to FIG. 18, the second pivot shaft support portion of the right and left pivot frames 18 may be constituted as a pivot block 19 as a separate body from a main body side that defines most part of the pivot frame 18. The pivot block 19 is fastened and fixed to the main body side of the pivot frame 18 by a bolt along the forward-rearward direction. A plurality of types of pivot blocks 19 in which the axis center position of the pivot shaft 33 can be changed may be set. At this time, a plurality of types of pivot adjusters 19a selected in accordance with the axis center position of the pivot shaft 33 are set in the first pivot shaft support portion of the mount portion 56. For example, front end portions of the right and left step brackets 27a on the same side may be fastened and fixed to the right and left pivot blocks 19. The step bracket 27a defines a V shape that protrudes rearward in a side view and has a rear end portion that supports the step 27 such that the step 27 can be laid. Upper and lower front end portions of the step bracket 27a butt a rear end portion of the pivot block 19 from right and left outer sides and are fastened and fixed by a bolt along the rightward-leftward direction.

By employing a configuration in which the pivot block 19 and the step bracket 27a are integrally attachable to and detachable from the main body side of the pivot frame 18, in a vehicle in which the power unit 8 is mounted at a rearward side of the pivot frame 18, a space for attaching and detaching the power unit 8 is easily ensured, and attachment and detachment works of the power unit 8 are facilitated.

A lower end section of the mount portion 56 is fastened to the lower cross member 23 at one point, and thereby, the following advantages are achieved. That is, the position of the lower fastening portion 58 is lowered downward to increase the distance between the upper fastening portion 57 and the lower fastening portion 58, a fastening region (region surrounded by a plurality of fastening portions) of the mount portion 56 is enlarged to increase a joint stiffness, the number of the lower fastening portion 58 is one which is the minimum number, and thereby, it is possible to reduce the rightward-leftward width of the vehicle body lower part close to the ground.

By forming the mount portion 56 such that the rightward-leftward width is narrowed toward the lower side, the right and left pivot frames 18 are also formed such that the rightward-leftward width is narrowed toward the lower side. Thereby, the rightward-leftward width of the lower portion of the pivot frame 18 is narrowed, and a vehicle body bank angle is reliably ensured.

The mount portion 56 that supports the pivot shaft 33 improves a pivot stiffness by a stiffness improvement by the joint with the vehicle body frame 5, and a configuration that is also suitable for a high-power vehicle is obtained.

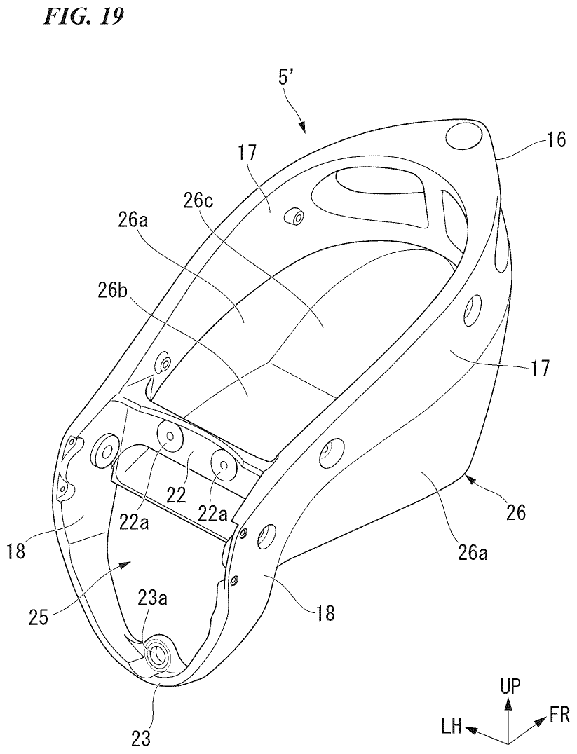

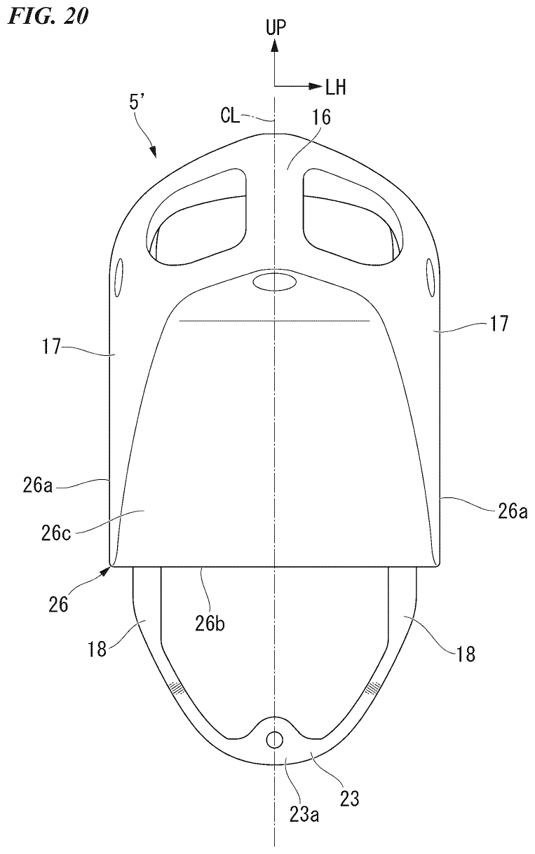

FIG. 19 is a perspective view showing a vehicle body frame 5′ of a second modification example of the embodiment, and FIG. 20 is a front view of a vehicle body frame 5′ of the second modification example.

With reference to FIG. 19 and FIG. 20, a configuration in which the vehicle body frame 5 continuously connects a region from a lower surface of the head pipe 16 to a front surface of the right and left pivot frames 18 is also conceivable.

The vehicle body frame 5′ shown in FIG. 19 and FIG. 20 includes a box shape part 26 which includes a pair of right and left side wall portions 26a that extend below the right and left main frames 17, respectively, a bottom wall portion 26b that connects lower ends of the right and left side wall portions 26a to each other, and a front wall portion 26c that connects front ends of the right and left side wall portions 26a to each other. The box shape part 26 is used as a support structure of the battery unit 80 mounted between the right and left main frames 17. The box shape part 26 enhances the stiffness of the vehicle body frame 5′ on which a heavy object (drive system component) such as the battery unit 80, the PCU 90, and the power unit 8 is mounted. For example, an outer circumference portion of the PCU 90 is fixed to an outer circumference of a lower surface of a bottom wall portion 26b of the box shape part 26 by fastening. Thereby, the bottom wall portion 26b is reinforced by the PCU 90, and the stiffness of the vehicle body frame 5′ can be further enhanced.

As described above, the saddle riding type electric vehicle in the embodiment described above includes: the vehicle body frame 5 having a head portion (head pipe 16) that supports a steering wheel (front wheel 2) in a steerable manner, the pair of right and left main frames 17 that branch to the right and the left from the head pipe 16 and extend rearward, the pair of right and left pivot frames 18 that extend downward from rear end portions of the right and left main frames 17, respectively, and the upper and lower cross members 22, 23 that connect the right and left pivot frames 18 to each other; the swing arm 30 that has a front end portion which is supported by the right and left pivot frames 18 and a rear end portion which supports a drive wheel (rear wheel 3); and the power unit 8 that includes the electric motor 50 for driving a vehicle and is arranged at a further rearward side than the right and left pivot frames 18 in a vehicle side view, wherein the power unit 8 includes at least the unit case 53 that accommodates the electric motor 50, the unit case 53 includes the mount portion 56 that is fastened by the upper and lower cross members 22, 23 in a vehicle forward-rearward direction between the right and left pivot frames 18, and the pivot shaft 33 of the swing arm 30 is supported by the right and left pivot frames 18 and the mount portion 56.

According to this configuration, the mount portion 56 that is fastened to the vehicle body frame 5 in the vehicle forward-rearward direction is provided on the unit case 53 of the power unit 8 that includes the electric motor 50 for driving the vehicle, and thereby, the following advantages are achieved. That is, a structure is obtained in which a connection portion between the vehicle body frame 5 and the power unit 8 easily receives a load (load accompanied by acceleration and deceleration of the vehicle) due to the output and the input of the electric motor 50. Therefore, it is possible to reduce (disperse) the load on a fastening portion of the power unit 8 and facilitate the adjustment of the strength and the stiffness of the unit case 53 and the entire vehicle body. The pivot shaft 33 of the swing arm 30 is supported by the right and left pivot frames 18 and the unit case 53, and thereby, it is possible to facilitate the adjustment of the strength and the stiffness of the unit case 53 and optimize a case rigidity compared to the case where the pivot shaft 33 is supported only by the unit case 53.

In the saddle riding type electric vehicle described above, the cross member 22, 23 includes the upper cross member 22 that connects upper portions of the right and left pivot frames 18 to each other and the lower cross member 23 that connects lower portions of the right and left pivot frames 18 to each other, the upper fastening portion 57 that is fastened to the upper cross member 22 is provided on an upper portion of the mount portion 56, the lower fastening portion 58 that is fastened to the lower cross member 23 is provided on a lower portion of the mount portion 56, and the lower fastening portion 58 is fastened to the lower cross member 23 in a further inner range in the vehicle width direction than the upper fastening portion 57.

According to this configuration, the lower fastening portion 58 of the unit case 53 is fastened to the lower cross member 23 in the further inner range in the vehicle width direction than the upper fastening portion 57, and thereby, it is possible to narrow a rightward-leftward width of a lower portion of the unit case 53 as much as possible and easily ensure a bank angle of the vehicle body. Specifically, the number of the lower fastening portion 58 is one which is the minimum number at the middle in the vehicle width direction, and thereby, it is possible to reduce the rightward-leftward width of the vehicle body lower part close to the ground as much as possible.

In the saddle riding type electric vehicle described above, each of the right and left pivot frames 18 may include the pivot block 19 as a separate body with respect to a main body side of the pivot frames 18, and each of right and left pivot blocks 19 may support the pivot shaft 33 of the swing arm 30 and may be fastened in the vehicle forward-rearward direction with respect to the main body side of a right or left pivot frame 18 on an identical side.

According to this configuration, by supporting the pivot shaft 33 by the pivot block 19 as the separate body with respect to the main body side of the pivot frame 18 and fastening the pivot block 19 in the vehicle forward-rearward direction with respect to the main body side of the pivot frame 18, the range of the fastening portion in the vehicle forward-rearward direction together with the fastening portion of the unit case 53 is enlarged, and it is possible to enhance the joint stiffness to the main body side of the vehicle body frame 5 of a unit case assembly body including the pivot block 19 and the pivot shaft 33. The assembly body of the power unit 8, the pivot shaft 33, and the pivot block 19 can be attached together to the main body side of the vehicle body frame 5 by the fastening in the forward-rearward direction.

In the saddle riding type electric vehicle described above, the right or left step 27 on an identical side may be attached to each of the right and left pivot blocks 19.

According to this configuration, by supporting the step 27 by the right and left pivot blocks 19, it is possible to receive a step load by the pivot block 19 having a high strength. Thereby, since the vehicle body frame 5 is not affected by the strength securement of a step attachment portion, it is possible to facilitate the adjustment of the strength and the stiffness of the main body side of the vehicle body frame 5.

In the saddle riding type electric vehicle described above, a plurality of types of the right and left pivot blocks 19 having a different axis center position of the pivot shaft 33 may be set.

According to this configuration, by setting a plurality of types of the pivot blocks 19 by differentiating the center position of the pivot shaft 33, it is possible to easily change a pivot position by replacing the pivot block 19, and it is possible to enhance the versatility of the vehicle component.

The saddle riding type electric vehicle described above includes: the rear cushion 32 that is connected to the swing arm 30 via the link mechanism 31, wherein the rear cushion 32 is arranged above the power unit 8 in an attitude in which a stroke direction is directed in the vehicle forward-rearward direction, has a front end portion that is connected to the power unit 8 at a further forward side than the drive shaft 50a of the electric motor 50, and has a rear end portion that is connected to the swing arm 30 at a further rearward side than the drive shaft 50a of the electric motor 50.

According to this configuration, the rear cushion 32 is arranged so as to extend in the vehicle forward-rearward direction across the drive shaft 50a of the electric motor 50, the front end portion of the rear cushion 32 is connected to the power unit 8, and the rear end portion of the rear cushion 32 is connected to the swing arm 30 via the link mechanism 31. By connecting the front end portion of the rear cushion 32 to a section to which the vehicle body frame 5 and the power unit 8 are fastened to enhance the stiffness, it is possible to support the front end portion of the rear cushion 32 with a high stiffness without additionally providing a reinforcement at the connection section of the front end portion of the rear cushion 32. Since the rear cushion 32 extends in the vehicle forward-rearward direction across the drive shaft 50a of the electric motor 50 above the power unit 8, it is possible to efficiently ensure a stroke amount of the rear cushion 32 while avoiding the power unit 8 arranged at the rearward side of the pivot frame 18 and prevent a retreat of the rear wheel 3 and an increase in a wheelbase compared to the case where the rear cushion 32 is arranged between the power unit 8 and the rear wheel. It is also possible to connect the front end portion of the rear cushion 32 to the vehicle body frame 5 instead of the power unit 8. That is, the cushion front connection section 56d can be provided on the upper cross member 22 or the like.

In the saddle riding type electric vehicle described above, the swing arm 30 includes the pair of right and left arm main bodies 36 and the arm connection portion 37 that connects the right and left arm main bodies 36 to each other, the right and left arm main bodies 36 are curved so as to be protrude upward in a vehicle side view, the arm connection portion 37 connects upper end portions of the right and left arm main bodies 36 to each other, and the link mechanism 31 that connects a rear end portion of the rear cushion 32 to the swing arm 30 is arranged on an inside of the arm connection portion 37.

According to this configuration, the right and left arm main bodies 36 of the swing arm 30 have a bent shape that protrudes upward, and the upper end portions of the right and left arm main bodies 36 are connected by the arm connection portion 37. Since the arm connection portion 37 is arranged close to an upper portion of the swing arm 30, the right and left arm main bodies 36 are efficiently connected to each other while avoiding the power unit 8 at the rearward side of the pivot frame 18, and the rear end portions of the rear cushion 32 arranged above the power unit 8 are easily connected. Since the link mechanism 31 that is connected to the rear end portion of the rear cushion 32 is arranged at the inside of the arm connection portion 37, the setting flexibility of suspension characteristics is enhanced by the link mechanism 31, and it is possible to compactly constitute a link-type rear suspension.

In the saddle riding type electric vehicle described above, the vehicle body frame 5′ may include: the box shape part 26 which includes the pair of right and left side wall portions 26a that extend below the right and left main frames 17, respectively, the bottom wall portion 26b that connects lower ends of the right and left side wall portions 26a to each other, and the front wall portion 26c that connects front ends of the right and left side wall portions 26a to each other.

According to this configuration, the box shape part 26 including the right and left side wall portions 26a, the bottom wall portion 26b, and the front wall portion 26c is provided below the right and left main frames 17 of the vehicle body frame 5′, and thereby, the box shape part 26 can be utilized as a support structure of the battery unit 80 mounted between the right and left main frames 17. Thereby, the number of components is reduced by eliminating or simplifying a structure for supporting the battery unit 80, and the stiffness of the vehicle body frame 5′ on which the battery unit 80 which is a heavy object is mounted can be enhanced by the box shape part 26.

The saddle riding type electric vehicle described above may include: a control device (PCU 90) that controls driving of the electric motor 50, wherein the PCU 90 may be fastened to a lower surface of the bottom wall portion 26b of the box shape part 26.

According to this configuration, by fastening the PCU 90 to the lower surface of the box shape part 26 of the vehicle body frame 5′, the number of components is reduced by eliminating or simplifying a structure for supporting the PCU 90, the bottom wall portion 26b of the box shape part 26 is reinforced by the fastening of the PCU 90, and it is possible to further enhance the stiffness of the vehicle body frame 5′.

In the saddle riding type electric vehicle described above, the electric motor 50 may be arranged at a height that overlaps the PCU 90 when seen from the vehicle forward-rearward direction.

According to this configuration, by arranging the PCU 90 and the electric motor 50 at the height that overlaps each other, not only the PCU 90 and the battery unit 80 mounted at the inside of the box shape part 26 are close to each other, but also the PCU 90 and the electric motor 50 are close to each other. Thereby, it is possible to shorten an electric power line among the battery unit 80, the PCU 90, and the electric motor 50 and concentrate the mass by a collected arrangement of heavy objects.

In the saddle riding type electric vehicle described above, the electric motor 50 and the drive wheel (rear wheel 3) are connected via a transmission member (drive chain 73) having an endless form, and the tensioner 75 that applies a tension to the drive chain 73 is supported by the unit case 53 of the power unit 8.

According to this configuration, by supporting the tensioner 75 for the drive chain 73 by the unit case 53, it is possible to efficiently apply the tension to the drive chain 73 in the vicinity of the power unit 8.

The present invention is not limited to the embodiment described above, and, for example, the configuration of the present embodiment may be applied to saddle riding vehicles other than motorcycles. The saddle riding vehicles include all vehicles on which a driver rides by straddling the vehicle body and include not only motorcycles (including motorized bicycles and scooter-type vehicles) but also three-wheeled vehicles (including vehicles having two front wheels and one rear wheel in addition to vehicles having one front wheel and two rear wheels) or four-wheeled vehicles (a four-wheeled buggy or the like).

The configuration in the embodiment described above is an example of the present invention, and various changes can be made without departing from the scope of the present invention such as replacing the components of the embodiment with well-known components.

What is claimed is:

1. A saddle riding type electric vehicle comprising:
a vehicle body frame having a head portion that supports a steering wheel in a steerable manner, a main frame that extends rearward from the head portion, a pair of right and left pivot frames that extend downward from a rear end portion of the main frame, and a cross member that connects the right and left pivot frames to each other;
a swing arm that supports a drive wheel; and
a power unit that includes an electric motor for driving a vehicle and is arranged at a further rearward side than the pivot frame in a vehicle side view,
wherein the power unit includes a unit case that accommodates the electric motor,
the unit case includes a mount portion that is fastened by the cross member in a vehicle forward-rearward direction between the right and left pivot frames, and
a pivot shaft of the swing arm is supported by the right and left pivot frames and the mount portion.

2. The saddle riding type electric vehicle according to claim 1,
wherein the cross member includes an upper cross member that connects upper portions of the right and left pivot frames to each other and a lower cross member that connects lower portions of the right and left pivot frames to each other,
an upper fastening portion that is fastened to the upper cross member is provided on an upper portion of the mount portion,
a lower fastening portion that is fastened to the lower cross member is provided on a lower portion of the mount portion, and
the lower fastening portion is fastened to the lower cross member in a further inner range in a vehicle width direction than the upper fastening portion.

3. The saddle riding type electric vehicle according to claim 1,
wherein each of the right and left pivot frames includes a pivot block as a separate body with respect to a main body side of the pivot frames, and
each of right and left pivot blocks supports the pivot shaft of the swing arm and is fastened in the vehicle forward-rearward direction with respect to the main body side of a right or left pivot frame on an identical side.

4. The saddle riding type electric vehicle according to claim 3,
wherein a right or left step on an identical side is attached to each of the right and left pivot blocks.

5. The saddle riding type electric vehicle according to claim 3,
wherein a plurality of types of the right and left pivot blocks having a different axis center position of the pivot shaft are set.

6. The saddle riding type electric vehicle according to claim 3, comprising:
a rear cushion that is connected to the swing arm,
wherein the rear cushion is arranged above the power unit in an attitude in which a stroke direction is directed in the vehicle forward-rearward direction, has a front end portion that is connected to the vehicle body frame or the power unit at a further forward side than a drive shaft of the electric motor, and has a rear end portion that is connected to the swing arm at a further rearward side than the drive shaft of the electric motor.

7. The saddle riding type electric vehicle according to claim 6,
wherein the swing arm includes a pair of right and left arm main bodies and an arm connection portion that connects the right and left arm main bodies to each other,
the right and left arm main bodies is curved so as to be protrude upward in a vehicle side view,
the arm connection portion connects upper end portions of the right and left arm main bodies to each other, and
a link mechanism that connects the rear end portion of the rear cushion to the swing arm is arranged on an inside of the arm connection portion.

8. The saddle riding type electric vehicle according to claim 3,
wherein the vehicle body frame includes: a box shape part which includes a pair of right and left side wall portions that extend below the right and left main frames, respectively, a bottom wall portion that connects lower ends of the right and left side wall portions to each other, and a front wall portion that connects front ends of the right and left side wall portions to each other.

9. The saddle riding type electric vehicle according to claim 8, comprising:
a control device that controls driving of the electric motor,
wherein the control device is fastened to a lower surface of the bottom wall portion of the box shape part.

10. The saddle riding type electric vehicle according to claim 3,
wherein the electric motor is arranged at a height that overlaps the control device when seen from the vehicle forward-rearward direction.

11. The saddle riding type electric vehicle according to claim 3,
wherein the electric motor and the drive wheel are connected via a transmission member having an endless form, and
a tensioner that applies a tension to the transmission member is supported by the unit case of the power unit.
